(19) United States
(12) Patent Application Publication
(10) Pub. No.: US 2012/0127344 A1
(43) Pub. Date: May 24, 2012

(54) IMAGE PICKUP DEVICE

(75) Inventors: Takashi Yanada, Tokyo (JP); Yoshinobu Tanaka, Tokyo (JP)

(73) Assignee: OLYMPUS CORPORATION, Tokyo (JP)

(21) Appl. No.: 13/290,303

(22) Filed: Nov. 7, 2011

(30) Foreign Application Priority Data
Nov. 22, 2010 (JP) 2010-260496

(51) Int. Cl. H04N 5/76

(52) U.S. Cl. 348/231.99; 348/E05.024

(57) ABSTRACT

An image pickup device may include an image pickup unit that includes two-dimensionally arranged pixels, the image pickup unit generating image signals of a plurality of series based on light incident to the pixels, the image pickup unit outputting the image signals of the plurality of series in parallel, a memory that stores the image signals output from the image pickup unit, a reading unit that sequentially reads the image signals from the memory, the reading unit sequentially outputting the image signals of the pixels as an image signal of one series in the same order as an alignment order of the pixels in a line direction, and an evaluation value calculating unit that processes the image signals output from the reading unit, the evaluation value calculating unit calculating an evaluation value necessary for controlling image pickup.

### BACKGROUND OF THE INVENTION

1. Field of the Invention

The present invention relates to an image pickup device.

Priority is claimed on Japanese Patent Application No. 2010-260496, filed Nov. 22, 2010, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

As the speed of image pickup devices increases, an imager (an image pickup element), which divides image data into image data of a plurality of series based on signals read from pixels and simultaneously outputs the image data of the plurality of series, has been used in digital cameras or the like. As the imager, there is an imager that outputs image data in two series using image data of two pixels adjacent in a horizontal direction or a vertical direction as a simultaneous output unit (for example, see Japanese Unexamined Patent Application, First Publication No. 2008-5048). In the future, an output form of the imager is expected to employ various forms according to further improvements in performance. However, it is desirable to cope with various output forms using an image pickup processing unit (a so-called image pickup sub system) of the same configuration regardless of the output form of the imager.

FIG. 8 illustrates a configuration of an image pickup device including an imager that outputs image data in two series. The image pickup device illustrated in FIG. 8 includes an image pickup unit 1 (an imager), image processing units 2 and 3, an automatic exposure (AE) evaluation value calculating unit 4, and an auto-focus (AF) evaluation value calculating unit 5. The image pickup unit 1 includes pixels that are two-dimensionally arranged, generates image data of two series based on light incident to the pixels, and outputs the image data of the two series to two channels ch1 and ch2 in parallel. The pixels are arrayed in the form of a Bayer array that includes one red pixel R, two green pixels Gr and Gb, and one blue pixel B as an array unit. The image processing unit 2 performs image processing, such as a resizing process of changing the image size, on image data output to one of the two channels. The image processing unit 3 performs image processing, such as a resizing process, on image data output to the other of the two channels.

The AE evaluation value calculating unit 4 and the AF evaluation value calculating unit 5 calculate evaluation values necessary for image pickup control. The AE evaluation value calculating unit 4 calculates an AE evaluation value used for general AE control. The AE evaluation value calculating unit 4 includes a selecting unit 41 that selects image data used for a calculation of the AE evaluation value. The AF evaluation value calculating unit 5 calculates an AF evaluation value used for general AF control. The AF evaluation value calculating unit 5 includes a Y generating unit 51 that generates brightness (Y) data used for a calculation of the AF evaluation value.

An optical system for forming an image based on light from a subject through the image pickup unit 1, a display unit for displaying an image based on image data processed by the image processing units 2 and 3, a recording unit for recording image data processed by the image processing units 2 and 3, a control unit for performing image pickup control using the AE evaluation value calculated by the AE evaluation value calculating unit 4 and the AF evaluation value calculated by the AF evaluation value calculating unit 5, and the like are omitted from FIG. 8.

The image data of the two channels is input to the AE evaluation value calculating unit 4, but the selecting unit 41 alternately switches the image data of each channel so that the image data of each channel can be output to a processing circuit of a subsequent stage as image data of one series. Therefore, a processing circuit for processing image data of one series can be used as a processing circuit of a subsequent stage of the selecting unit 41.

The image data of the two channels is input to the AF evaluation value calculating unit 5, but the Y generating unit 51 adds the image data of the channels, generates brightness data and outputs the brightness data to a processing circuit of a subsequent stage as brightness data of one series. Therefore, a processing circuit for processing image data of one series can be used as a processing circuit of a subsequent stage of the Y generating unit 51. As described above, since the selecting unit 41 and the Y generating unit 51 are added to the AE evaluation value calculating unit 4 and the AF evaluation value calculating unit 5, which each include the processing circuit for processing the image data of one series, it is possible to easily cope with an imager having various output forms.

In general, when the AE evaluation value and the AF evaluation value are calculated, integration of image data of each division area obtained by dividing an area of one screen in a lattice form is performed. However, in the image pickup device illustrated in FIG. 8, the selecting unit 41 of the AE evaluation value calculating unit 4 selects only image data of one channel from image data of two channels which are input at the same time and alternately switches a channel to select. Thus, a part of image data is thinned out, and it is difficult to secure image data necessary for generation of the evaluation value, leading to degradation of the accuracy of the evaluation value.

In addition, in the image pickup device illustrated in FIG. 8, when the Y generating unit 51 of the AF evaluation value calculating unit 5 generates the brightness data from the image data of the two channels which are input at the same time, it is difficult to secure brightness data of the number necessary for generation of the evaluation value, leading to degradation of the accuracy of the evaluation value. FIGS. 9A and 9B and FIGS. 10A and 10B are diagrams illustrating pixels of the Bayer array in accordance with the related art. For example, when image data of two pixels adjacent in the horizontal direction is input at the same time, brightness data is generated from four pixels surrounded by a dashed line of FIG. 9A, but the brightness data is not generated from four pixels surrounded by an alternate long and short dashed line of FIG. 9B. In addition, when image data of two pixels adjacent in the vertical direction is input at the same time, brightness data is generated from four pixels surrounded by a dashed line of FIG. 10A, but the brightness data is not generated from four pixels surrounded by an alternate long and short dashed line of FIG. 10B.

### SUMMARY

The present invention provides an image pickup device capable of reducing a decrease in accuracy of an evaluation value.

An image pickup device may include: an image pickup unit that includes two-dimensionally arranged pixels, the image pickup unit generating image signals of a plurality of series based on light incident to the pixels, the image pickup unit outputting the image signals of the plurality of series in parallel; a memory that stores the image signals output from the image pickup unit; a reading unit that sequentially reads the image signals from the memory, the reading unit sequentially outputting the image signals of the pixels as an image signal of one series in the same order as an alignment order of the pixels in a line direction; and an evaluation value calculating unit that processes the image signals output from the reading unit, the evaluation value calculating unit calculating an evaluation value necessary for controlling image pickup.

In a first mode, the reading unit may sequentially read the image signals from the memory and sequentially output the image signals of one series in the same order as the alignment order of the pixels in the line direction. In a second mode, the reading unit may sequentially read the image signals from the memory and sequentially output the image signals of the plurality of series that are identical to the image signals of the plurality of series output from the image pickup unit.

The reading unit may sequentially read the image signals such that overwriting is not performed before the image signal stored in the memory is read.

The reading unit may read the image signals from the memory in synchronization with a read clock that is higher in speed than an image pickup clock of the image pickup unit.

According to the present invention, by storing image signals of a plurality of series output in parallel from an image pickup unit in a memory, sequentially reading the image signals from the memory, and sequentially outputting the image signal of each pixel as an image signal of one series in the same order as an alignment order of pixels in a line direction, an image signal necessary for generation of an evaluation value can be secured. Thus, a decrease in accuracy of the evaluation value can be reduced.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a configuration of an image pickup device in accordance with a first preferred embodiment of the present invention;

FIG. 2 is a timing chart illustrating an operation of the image pickup device in accordance with the first preferred embodiment of the present invention;

FIG. 3 is a timing chart illustrating an operation of the image pickup device in accordance with the first preferred embodiment of the present invention;

FIG. 4 is a block diagram illustrating a configuration of an image pickup device in accordance with the second preferred embodiment of the present invention;

FIG. 5 is a block diagram illustrating an operation of the image pickup device in accordance with to the second preferred embodiment of the present invention;

FIG. 6 is a timing chart illustrating an operation of the image pickup device in accordance with the second preferred embodiment of the present invention;

FIG. 7 is a timing chart illustrating an operation when an image pickup unit that outputs image data of only one series is provided instead of the image pickup unit 1 that outputs image data of two series;

FIG. 8 is a block diagram illustrating an image pickup device including an imager that outputs image data in two series;

FIGS. 9A and 9B are diagrams illustrating pixels of the Bayer array in accordance with the related art; and

FIGS. 10A and 10B are diagrams illustrating pixels of the Bayer array in accordance with the related art.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

### First Preferred Embodiment

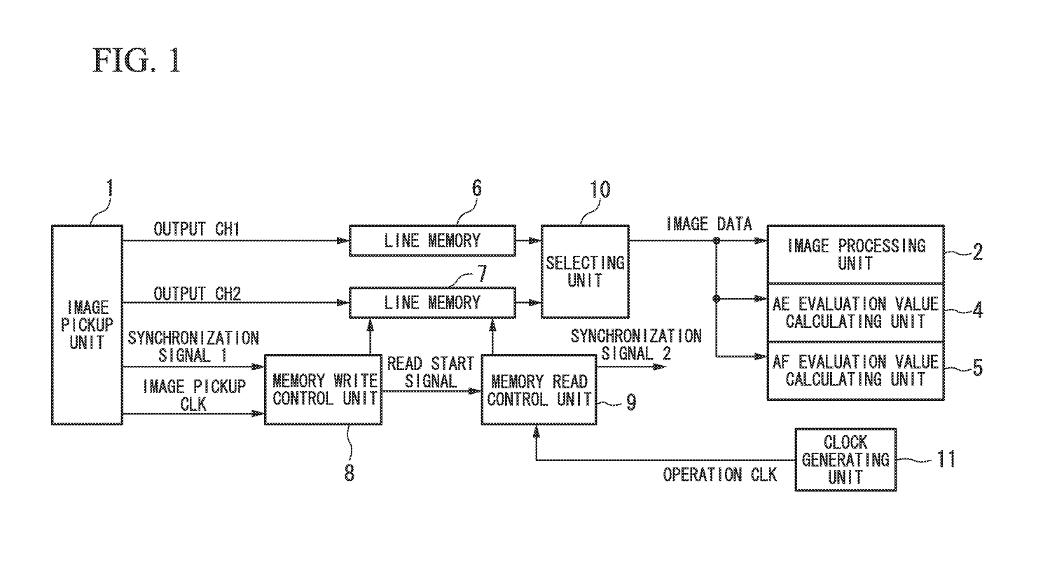

First, a first preferred embodiment of the present invention will be described. FIG. 1 is a block diagram illustrating a configuration of an image pickup device in accordance with the first preferred embodiment of the present invention. The image pickup device illustrated in FIG. 1 includes an image pickup unit 1, an image processing unit 2, an AE evaluation value calculating unit 4, an AF evaluation value calculating unit 5, line memories 6 and 7, a memory write control unit 8, a memory read control unit 9, a selecting unit 10, and a clock generating unit 11.

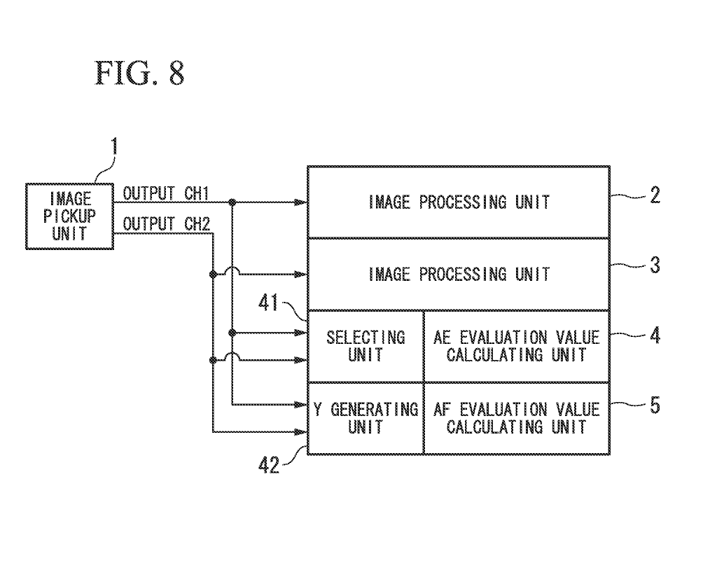

The image pickup unit 1 the image processing unit 2, the AE evaluation value calculating unit 4, and the AF evaluation value calculating unit 5 are the same in configuration as those illustrated in FIG. 8. The AF evaluation value calculating unit 5 includes a circuit for generating brightness data. The line memories 6 and 7 store image data (image signals) output from the image pickup unit 1 in line units. The line memory 6 stores image data output to one of the two channels, and the line memory 7 stores image data output to the other of the two channels.

The memory write control unit 8 controls writing of image data to the line memories 6 and 7. Writing of the image data to the line memories 6 and 7 starts in synchronization with a synchronization signal output from the image pickup unit 1, and image data of each pixel is written to the line memories 6 and 7 in synchronization with an image pickup clock output from the image pickup unit 1.

The memory read control unit 9 controls reading of image data from the line memories 6 and 7. When a certain amount (for example, an amount set by a central processing unit (CPU)) of image data is completely written to the line memories 6 and 7, reading of image data from the line memories 6 and 7 starts. Reading of image data of each pixel from the line memories 6 and 7 is performed in synchronization with an operation clock generated by the clock generating unit 11. The memory read control unit 9 starts reading of image data and generates a synchronization signal synchronized with the read image data. The synchronization signal generated by the memory read control unit 9 need not be synchronized with the synchronization signal output from the image pickup unit 1.

The selecting unit 10 alternately selects image data sequentially read and output from the line memories 6 and 7 and sequentially outputs image data of each pixel in the same order as an alignment order of pixels in a line direction as an image signal of one series. The clock generating unit 11 generates the operation clock synchronized with a system clock inside the image pickup device and outputs the operation clock to each component. An optical system, a display unit, a recording unit, a control unit, and the like are not shown in FIG. 1.

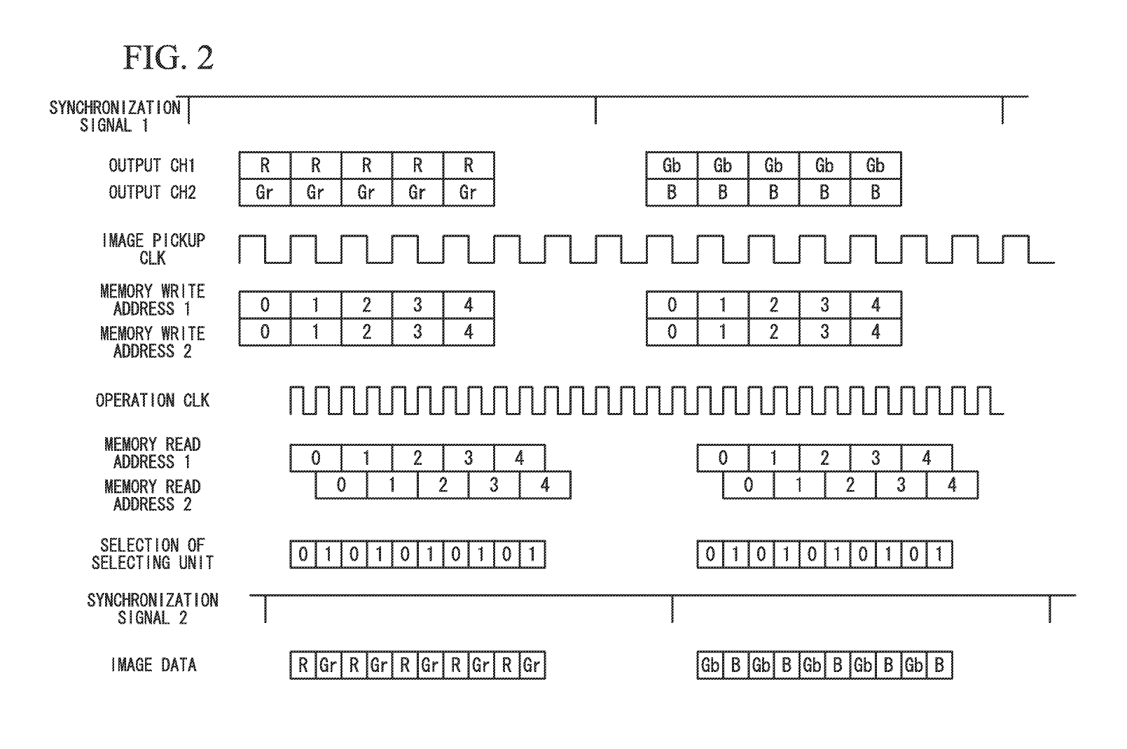

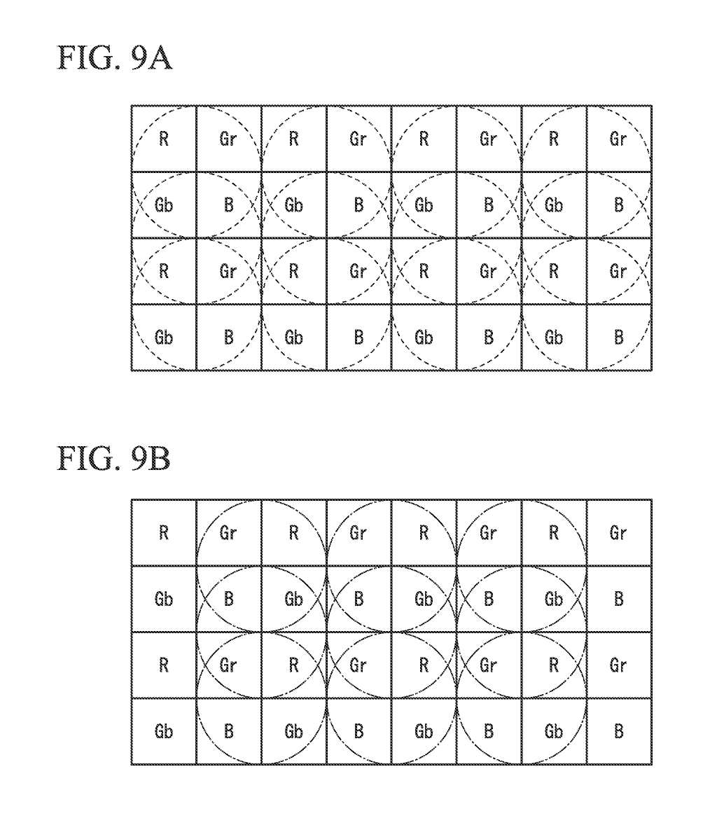

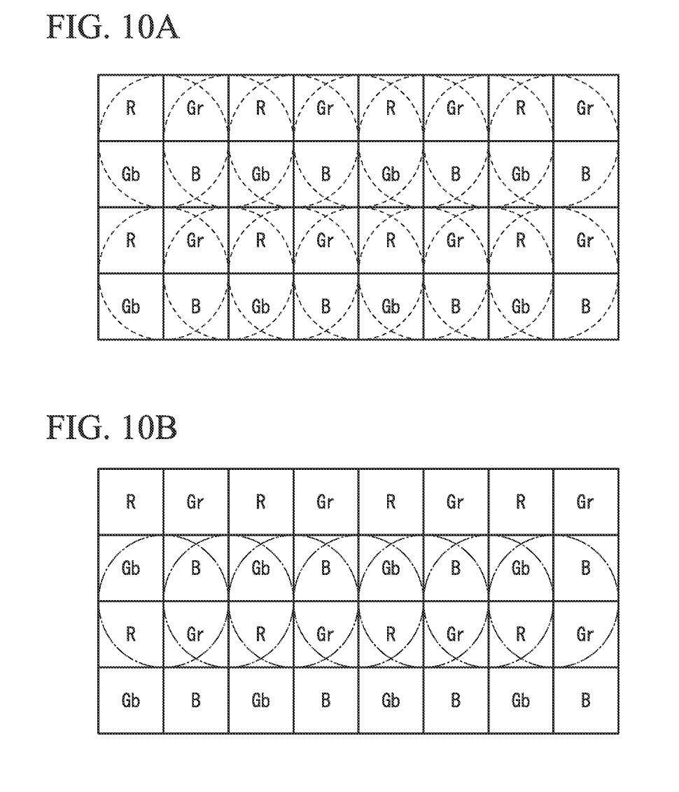

Next, an operation of the image pickup device will be described. FIG. 2 is a timing chart illustrating an operation of the image pickup device in accordance with the first preferred embodiment of the present invention. An operation in which the image pickup unit 1 simultaneously outputs image data of two pixels adjacent in the horizontal direction will be described with reference to FIG. 2. The image pickup unit 1 outputs image data of two pixels adjacent in the horizontal direction in the Bayer array illustrated in FIGS. 9A and 9B and FIGS. 10A and 10B to two channels ch1 and ch2. First, image data of a pixel R of a first line and image data of a pixel Gr of the first line are output during an initial output time period synchronized with a synchronization signal from the image pickup unit 1. The image data of the pixel R is output to one channel ch1, and the image data of the pixel Gr is output to the other channel ch2.

The image data output from the image pickup unit 1 is sequentially written to the line memories 6 and 7 in synchronization with an image pickup clock from the image pickup unit 1 according to control by the memory write control unit 8. When the image data of the two pixels is written to the line memories 6 and 7, reading of image data starts. Image data is sequentially read from the line memories 6 and 7 in synchronization with an operation clock from the clock generating unit 11 according to control by the memory read control unit 9.

Reading of the image data from the line memory 6 and reading of the image data from the line memory 7 are performed at different timings so that the image data can be alternately output from the line memories 6 and 7. Further, image data of each pixel is sequentially read so that new image data cannot be overwritten before image data of each pixel stored in the line memories 6 and 7 is read. Thus, the memory write control unit 8 controls writing of image data based on a write address indicated by a CPU (not shown) and outputs a read start signal for reading image data from a read address indicated by the CPU to the memory read control unit 9. The memory read control unit 9 controls reading of image data based on the read start signal. The read address on each line memory is controlled not to exceed (overtake) the write address.

In the present preferred embodiment, reading of image data from the line memories 6 and 7 is performed in synchronization with the operation clock, which has a higher speed than the image pickup clock. However, reading of image data may be performed in synchronization with a clock that has a lower speed than the image pickup clock if reading and writing of image data are controlled such that new image data is not overwritten before image data of each pixel stored in the line memories 6 and 7 is read. The memory read control unit 9 generates and outputs a synchronization signal during an output time period based on the synchronization signal from the image pickup unit 1 when reading of image data of each line starts.

The selecting unit 10 sequentially selects the image data of each pixel output from the line memories 6 and 7 during the output time period synchronized with the synchronization signal from the memory read control unit 9 and outputs the image data of each pixel in one series in a selected order. In the example illustrated in FIG. 2, the image data is output in an order of the image data of the pixel R, the image data of the pixel Gr, the image data of the pixel R, the image data of the pixel Gr, and so one. This order is the same as the alignment order of pixels of the first row in the line direction in the Bayer array.

Subsequently, image data of a pixel Gb of a second line and image data of a pixel B of the second line are output during a second output time period synchronized with the synchronization signal from the image pickup unit 1. The image data of the pixel Gb is output to one channel ch1, and the image data of the pixel B is output to the other channel ch2. A subsequent operation is the same as the operation when the image data of the first line is output from the image pickup unit 1. The image data is output from the selecting unit 10 in an order of the image data of the pixel Gb, the image data of the pixel B, the image data of the pixel Gb, the image data of the pixel B, and so on. This order is the same as the alignment order of pixels of the second row in the line direction in the Bayer array. By the above operation, the image data of each pixel is input to the AE evaluation value calculating unit 4 and the AF evaluation value calculating unit 5 in the same order as the alignment order of pixels in the line direction in the Bayer array.

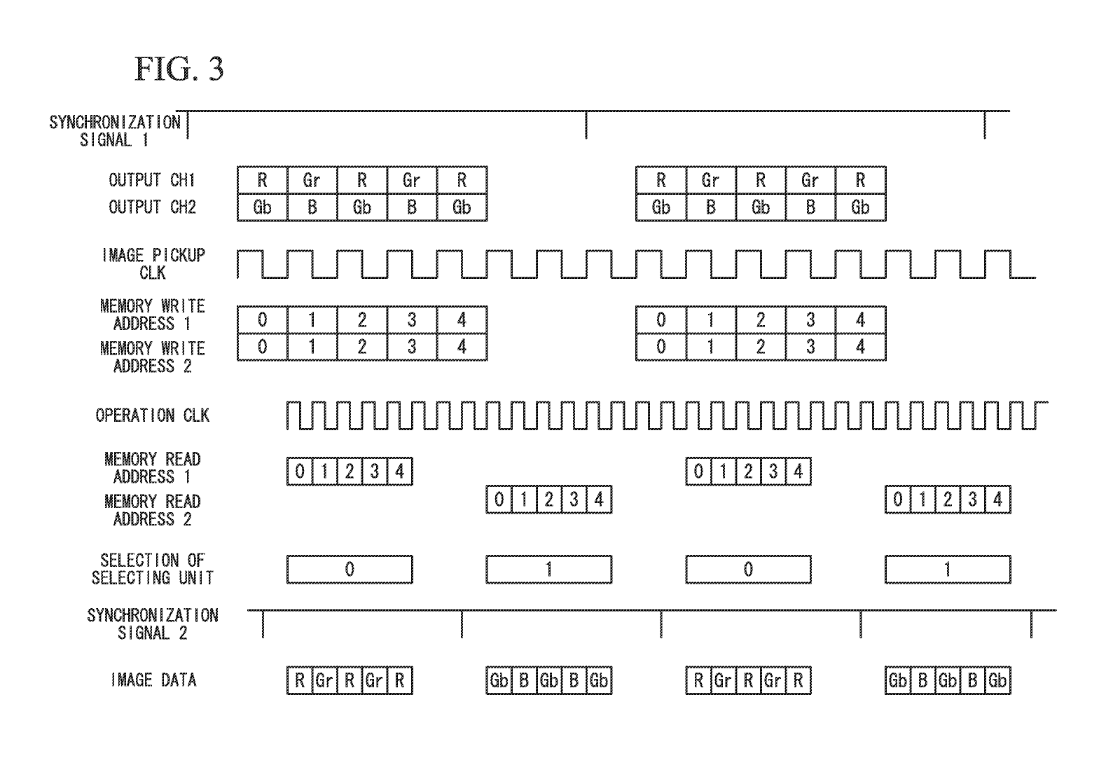

Next, an operation when the image pickup unit 1 simultaneously outputs image data of two pixels adjacent in the vertical direction will be described with reference to FIG. 3. FIG. 3 is a timing chart illustrating an operation of the image pickup device in accordance with the first preferred embodiment of the present invention. The image pickup unit 1 outputs image data of two pixels adjacent in the vertical direction in the Bayer array illustrated in FIGS. 9A and 9B and FIGS. 10A and 10B to two channels ch1 and ch2. First, image data of a pixel R of a first line and image data of a pixel Gb of a second line are output during an output time period synchronized with a synchronization signal from the image pickup unit 1. The image data of the pixel R is output to one channel ch1, and the image data of the pixel Gb is output to the other channel ch2.

Subsequently, image data of a pixel Gr of the first line and image data of a pixel B of the second line are output from the image pickup unit 1. The image data of the pixel Gr is output to one channel ch1, and the image data of the pixel B is output to the other channel ch2. Thereafter, the image data of the pixel R and the image data of the pixel Gr are alternately output to one channel ch1, and the image data of the pixel Gb and the image data of the pixel B are alternately output to the other channel ch2.

The image data output from the image pickup unit 1 is sequentially written to the line memories 6 and 7 in synchronization with an image pickup clock from the image pickup unit 1 according to control by the memory write control unit 8. When the image data of the two pixels is written to the line memories 6 and 7, reading of image data starts. Image data is sequentially read from the line memory 6 in synchronization with an operation clock from the clock generating unit 11 according to control by the memory read control unit 9. In addition, the memory read control unit 9 generates and output the synchronization signal during the output time period based on the synchronization signal from the image pickup unit 1 when reading of the image data from the line memory 6 starts.

The selecting unit 10 sequentially selects the image data of each pixel output from the line memory 6 during the output time period synchronized with the synchronization signal from the memory read control unit 9 and outputs the image data of each pixel in one series in a selected order. In the example illustrated in FIG. 3, the image data is output in an order of the image data of the pixel R, the image data of the pixel Gr, the image data of the pixel R, the image data of the pixel Gr, and so on. This order is the same as the alignment order of pixels of the first row in the line direction in the Bayer array.

When reading of image data from the line memory 6 is finished, reading of image data from the line memory 7 starts. The memory read control unit 9 generates and outputs the synchronization signal when reading of image data from the line memory 7 starts. The selecting unit 10 sequentially selects the image data of each pixel output from the line memory 7 during the output time period synchronized with the synchronization signal output from the memory read control unit 9 and outputs the image data of each pixel in one series in a selected order. In the example illustrated in FIG. 3, the image data is output in an order of the image data of the pixel Gb, the image data of the pixel B, the image data of the pixel Gb, the image data of the pixel B, and so one. This order is the same as the alignment order of pixels of the second row in the line direction in the Bayer array.

Subsequently, image data of a pixel R of a third line and image data of a pixel Gr of the third line are alternately output to one channel ch1 from the image pickup unit 1 during a second output time period synchronized with the synchronization signal from the image pickup unit 1, and image data of a pixel Gb of a fourth line and image data of a pixel B of the fourth line are alternately output to the other channel ch2. A subsequent operation is the same as the operation when the image data of the first line and the image data of the second line are output from the image pickup unit 1. By the above operation, image data of each pixel is input to the AE evaluation value calculating unit 4 and the AF evaluation value calculating unit 5 in the same order as the alignment order of pixels in the line direction in the Bayer array.

As described above, according to the present preferred embodiment, when image data is sequentially read and output from the line memories 6 and 7 in which image data of two series output in parallel from the image pickup unit 1 is stored, image data of each pixel is sequentially output as image data of one series in the same order as the alignment order of the pixels in the line direction, and thus image data necessary for generation of the AE evaluation value and the AF evaluation value can be secured. Accordingly, a decrease in accuracy of the evaluation value can be reduced. The present preferred embodiment has been described in connection with the example of outputting image data of two series from the image pickup unit 1. However, it is possible to cope by the same method even when the number of series of image data output from the image pickup unit 1 increases.

### Second Preferred Embodiment

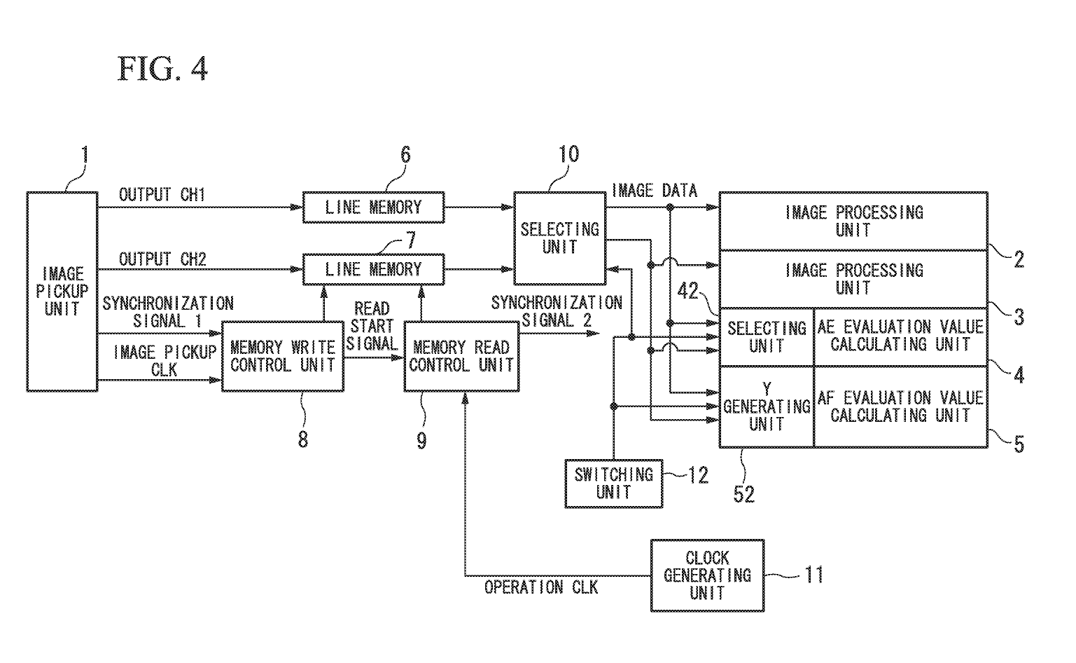

Next, a second preferred embodiment of the present invention will be described. FIG. 4 is a block diagram illustrating a configuration of an image pickup device in accordance with the second preferred embodiment of the present invention. In comparison with the configuration illustrated in FIG. 1, FIG. 4 additionally includes a selecting unit 42, a Y generating unit 52, and a switching unit 12. The selecting unit 42 selects image data used for a calculation of an AE evaluation value. The Y generating unit 52 generates brightness (Y) data used for a calculation of an AF evaluation value. The switching unit 12 outputs a switching signal for switching functions of the selecting unit 10, the selecting unit 42 and the Y generating unit 52 according to an operation mode of the image pickup device.

The image pickup device according to the present preferred embodiment can select a first mode for rearranging image data of two series output from the image pickup unit 1 to image data of one series and a second mode for outputting image data of two series output from the image pickup unit 1 to a processing circuit of a subsequent stage as is and can operate in either the first mode or the second mode. During an AF operation of performing AF control, since an input rate of valid image data used for processing is low and processing of rearranging image data of two series to image data of one series can be performed, the image pickup device operates in the first mode. In addition, during a still image capturing operation of capturing a still image, since an input rate of valid image data used for processing is high and it is difficult to perform processing of rearranging image data of two series to image data of one series, the image pickup device operates in the second mode.

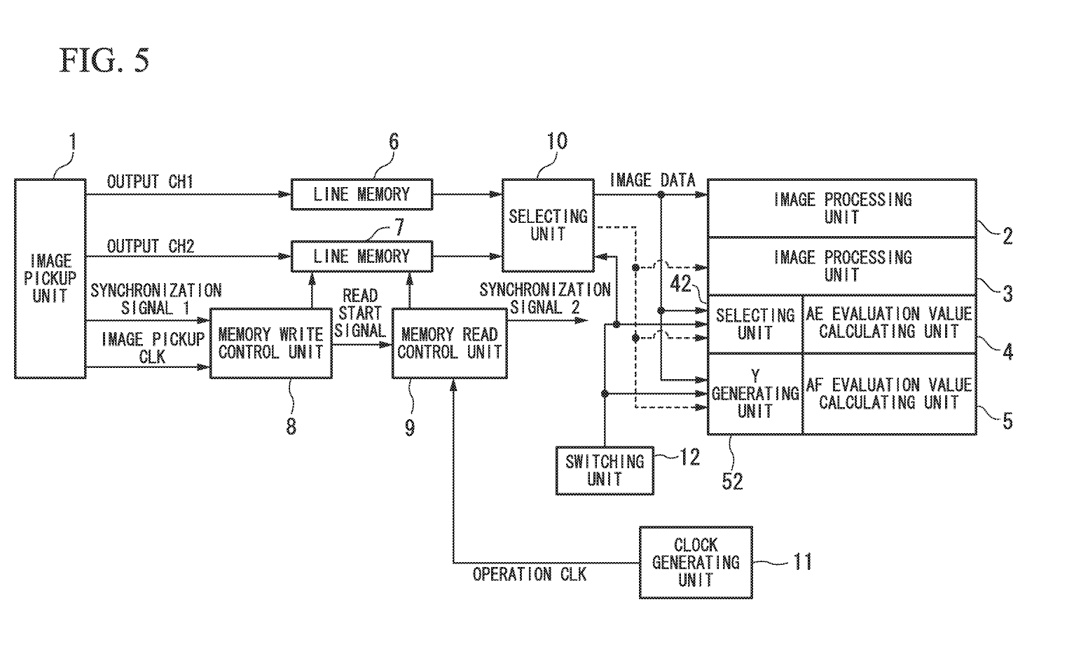

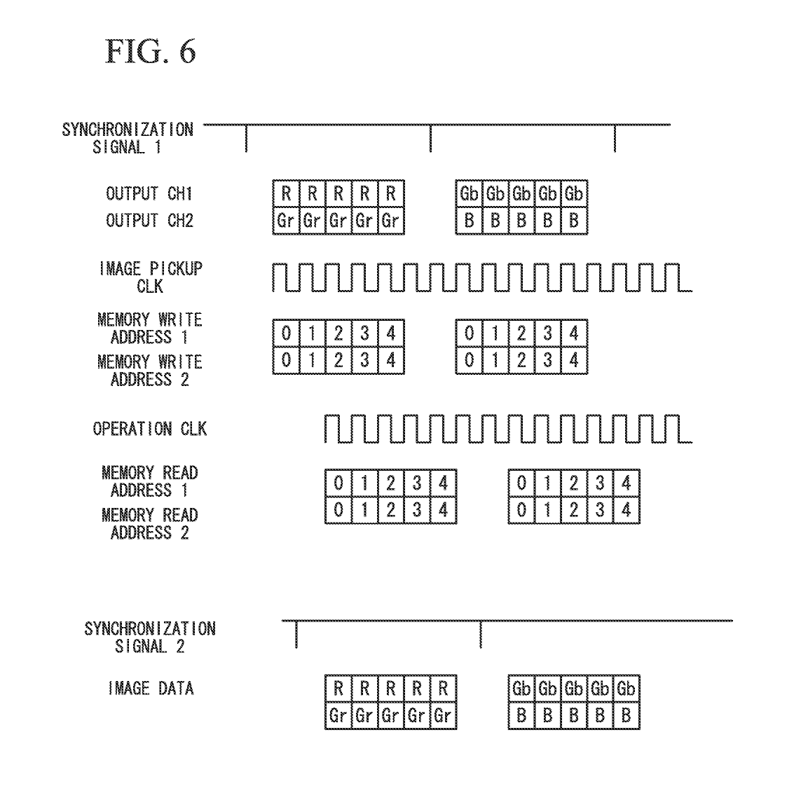

FIG. 5 is a block diagram illustrating an operation of the image pickup device in accordance with to the second preferred embodiment of the present invention. FIG. 6 is a timing chart illustrating an operation of the image pickup device in accordance with the second preferred embodiment of the present invention. During the AF operation, as illustrated in FIG. 5, the selecting unit 10 rearranges image data of two series stored in the line memories 6 and 7 to image data of one series based on a switching signal representing the first mode and then outputs the image data of one series. The selecting unit 42 outputs the image data input from the selecting unit 10 to the processing circuit of the subsequent stage as is based on the switching signal representing the first mode. The Y generating unit 52 generates brightness data using the image data input from the selecting unit 10 based on the switching signal representing the first mode and outputs the brightness data to the processing circuit of the subsequent stage. The brightness data generated by the Y generating unit 52 includes brightness data generated from four pixels surrounded by the dashed line of FIG. 9A, 9B, 10A, or 10B and brightness data generated from four pixels surrounded by the alternate long and short dashed line. In the above-described manner, data necessary for generation of the evaluation value is secured during the AF operation.

During the still image capturing operation, the selecting unit 10 outputs image data of two series stored in the line memories 6 and 7 as image data of two series as is based on a switching signal representing the second mode. The selecting unit 42 thins out the image data input from the selecting unit 10 based on the switching signal representing the second mode and outputs the thinned out image data to the processing circuit of the subsequent stage. The Y generating unit 52 generates brightness data using the image data input from the selecting unit 10 based on the switching signal representing the second mode and outputs the generated brightness data to the processing circuit of the subsequent stage. The brightness data generated by the Y generating unit 52 includes either brightness data generated from four pixels surrounded by the dashed line of FIG. 9A, 9B, 10A, or 10B or brightness data generated from four pixels surrounded by the alternate long and short dashed line. As described above, a part of data necessary for generation of the evaluation value is thinned out during the still image capturing operation.

As described above, according to the present preferred embodiment, image data can be processed according to a plurality of operation modes. The present preferred embodiment has been described in connection with the example in which image data of two series is output from the image pickup unit 1. However, it is possible to cope by the same method even when the number of series of image data output from the image pickup unit 1 increases. For example, it is possible to cope even when image data of two series is output from the image pickup unit 1 during the AF operation and image data of four series is output from the image pickup unit during the still image capturing operation.

Using Image Pickup Unit that Outputs Image Data of Only One Series

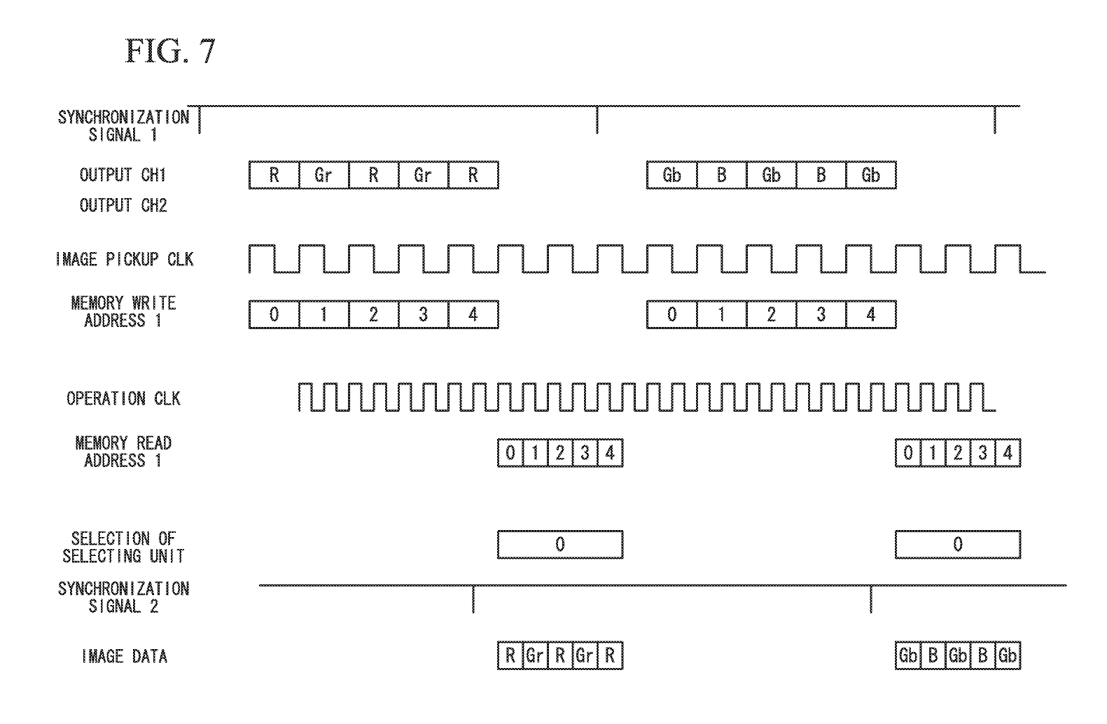

The image pickup devices illustrated in the first and second preferred embodiments may be provided with an image pickup unit that outputs image data of only one series. FIG. 7 is a timing chart illustrating an operation when an image pickup unit that outputs image data of only one series is provided instead of the image pickup unit 1 that outputs image data of two series. The image data of one series output from the image pickup unit is written only to the line memory 6. The selecting unit 10 selects image data output from the line memory 6 and outputs the image data as it is. As described above, it is possible to cope with an image pickup unit having a different output form. FIG. 8 is a block diagram illustrating an image pickup device including an imager that outputs image data in two series.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the invention is not to be considered as being limited by the foregoing description, and is only limited by the scope of the claims.

What is claimed is:

1. An image pickup device comprising:
an image pickup unit that includes two-dimensionally arranged pixels, the image pickup unit generating image signals of a plurality of series based on light incident to the pixels, the image pickup unit outputting the image signals of the plurality of series in parallel;
a memory that stores the image signals output from the image pickup unit;
a reading unit that sequentially reads the image signals from the memory, the reading unit sequentially outputting the image signals of the pixels as an image signal of one series in the same order as an alignment order of the pixels in a line direction; and
an evaluation value calculating unit that processes the image signals output from the reading unit, the evaluation value calculating unit calculating an evaluation value necessary for controlling image pickup.

2. The image pickup device according to claim 1, wherein
in a first mode, the reading unit sequentially reads the image signals from the memory and sequentially outputs the image signals of one series in the same order as the alignment order of the pixels in the line direction, and
in a second mode, the reading unit sequentially reads the image signals from the memory and sequentially outputs the image signals of the plurality of series that are identical to the image signals of the plurality of series output from the image pickup unit.

3. The image pickup device according to claim 1, wherein the reading unit sequentially reads the image signals such that overwriting is not performed before the image signal stored in the memory is read.

4. The image pickup device according to claim 3, wherein the reading unit reads the image signals from the memory in synchronization with a read clock that is higher in speed than an image pickup clock of the image pickup unit.
